(19) United States
(12) Patent Application Publication
(10) Pub. No.: US 2015/0014481 A1
(43) Pub. Date: Jan. 15, 2015

(54) RAIL MOUNTED BEVERAGE DISPENSER FOR COMMERCIAL AIRPLANES

(71) Applicant: The Boeing Company, Chicago, IL (US)

(72) Inventors: Cynthia A. Vandewall, Chicago, IL (US); Vicki A. Curtis, Stanwood, WA (US); Emily Beiting, Chicago, IL (US); Tom Coulter, Chicago, IL (US); Grace Ficke, Chicago, IL (US); Sang Hook Kim, Chicago, IL (US); Shyamal Ruparel, Chicago, IL (US); Steve Doehler, Chicago, IL (US)

(21) Appl. No.: 13/940,557

(22) Filed: Jul. 12, 2013

(51) Int. Cl. B64D 11/04

(52) U.S. Cl. CPC B64D 11/04
USPC 244/118.5

(57) ABSTRACT

A galley cart is suspended from a rail or track that extends along the length of an aircraft cabin above the aisle and rows of passenger seats of the aircraft. The galley cart is automated to move along the track above the aisle in response to movements of a flight attendant that is serving passengers from the suspended galley cart. The galley cart is provided with open bins for storage of food products, a beverage dispenser that is operable by the flight attendant to dispense a beverage requested by a passenger from a plurality of different beverages available from the suspended cart, and an ice dispenser for serving ice with the beverages requested by the passengers.

### FIELD

The present invention pertains to a rail mounted beverage and food product dispenser for a commercial aircraft.

In particular, the present invention pertains to a galley cart that is suspended from a rail or track that extends along the length of the aircraft cabin above the aisle of the aircraft. The galley cart is automated to move along the track above the aisle in response to movement of a flight attendant that is serving passengers from the suspended galley cart. The galley cart is provided with open bins for storage of food products, a beverage dispenser with a retractable hose where the dispenser is operable by the flight attendant to dispense a beverage requested by a passenger from a plurality of different beverages available from the suspended cart, and an ice dispenser for serving ice with the beverages requested by passengers.

### BACKGROUND

A typical commercial aircraft contains several galley carts for delivering food products and beverages to passengers of the aircraft and for collecting trash and recyclables from the passengers. A typical galley cart loaded with food products, canned and bottled beverages and ice can weigh up to 200 pounds, making it difficult to manually maneuver the cart up and down an aisle of the aircraft. To provide sufficient storage in the galley cart for the food products, the cart is dimensioned only slightly narrower than the aircraft cabin aisle, further making it difficult to maneuver the cart up and down the aisle. Due to the size and weight of the galley cart it can take one or more flight attendants up to 45 minutes to move the cart in a first direction down the aisle to deliver food products and beverages to the passengers, and then move the cart back in the opposite direction to retrieve trash and recyclables from the passengers. Additionally, at the end of each flight time is needed to remove the trash from the galley cart and to restock the galley cart with food products, beverages and ice for the next flight.

There is a need in the airline industry to update the typical galley cart to make it easier to deliver food products and beverages to passengers, to reduce the time needed to deliver food products and beverages and remove trash, and to restock the galley cart after each flight in a more time efficient manner.

### SUMMARY

The rail mounted food product and beverage dispensing galley cart of the present invention is a simple, sleek and efficient replacement for the bulky, obtrusive airline galley carts of yesterday. It is employed in a typical commercial aircraft having an aircraft cabin with a longitudinal length and a lateral width. The galley cart of the invention is suspended from a rail or track that extends longitudinally along the top of the aircraft cabin. The rail is positioned above the aisle between the pluralities of rows of seats, suspending the galley cart between the rows of seats and above the aisle. The cart itself is also detachable from the rail. Catering would detach the cart from the rail and then replace it with a cart that has been pre-stocked on the ground. This is to ensure that the time spent restocking the cart is at a minimum.

A motive device is provided at the connection between the galley cart and the rail. Selective operation of the motive device controls movement of the suspended galley cart longitudinally through the aircraft cabin between the front of the aircraft cabin and the rear of the aircraft cabin. A wireless control device is carried by a flight attendant and is operable to control the movements of the galley cart through the aircraft cabin. Thus, it is no longer necessary for a flight attendant to push or pull the galley cart through the cabin. Additionally, there could be other options for flight attendant operation. The attendant could push/pull the cart, the cart could follow the flight attendant with an RF sensor, or the cart could be motorized and move on its own with the flight attendant just controlling stop and start.

The suspended galley cart is provided with a plurality of open bins for storing food products, for example packages of snacks. The suspended galley cart is also provided with an ice dispenser for selectively dispensing cubed or crushed ice for drinks. A drink cup holder is provided on the suspended galley cart and a beverage dispenser is positioned adjacent the drink cups. The beverage dispenser consists of a retractable hose and hand held dispensing spout. The hand held dispensing spout at the end of the hose is provided with several control buttons for selectively dispensing a particular beverage associated with each button. In the galley area, the end of the retractable hose is connected to beverage containers. The beverage containers are stored out of sight of the passengers in designated closets or cabinets. Beverages could include syrups and carbonated water for making several carbonated drinks, non-carbonated water (hot and cold), coffee, etc. The beverage dispenser eliminates the need to open pop top cans for beverages and also eliminates the waste of empty cans.

By suspending the galley cart from the top of the aircraft cabin there is no longer a need for the serving attendant to stoop or bend over to open drawers to access beverages, food products or ice. The motive device of the suspended galley cart eliminates the physical labor required of the serving attendant in providing food products and beverages to passengers. Additionally, the suspended galley cart eliminates blocking the aircraft aisle with the heavy, bulky conventional galley cart and also eliminates the potential for passenger injuries from being struck by the prior art galley cart.

The features, functions and advantages that have been discussed can be achieved independently in various embodiments or may be combined in yet other embodiments further details of which can be seen with reference to the following description and drawings.

### BRIEF DESCRIPTION OF THE DRAWINGS

Further features of the rail mounted galley cart of the invention are set forth in the following detailed description of the aircraft employing the rail mounted galley cart and in the drawing figures.

FIG. 1 is a representation of a perspective view of the rail suspended food product and beverage dispensing galley cart of the invention positioned in a commercial aircraft cabin.

FIG. 2 is a representation of a plan view of an aircraft cabin containing the rail suspended galley cart of the invention.

FIG. 3 is a representation of a side elevation view of the rail suspended galley cart showing the vertical suspended position of the galley cart relative to a flight attendant.

FIG. 4 is a representation of a partial side elevation view of the suspended galley cart showing food product bins of the galley cart.

FIG. 5 is a representation of a partial side elevation view of the suspended galley cart showing food product bins of the galley cart and the beverage dispenser.

FIG. 6 is a representation of a partial side elevation view of the suspended galley cart showing an ice dispenser of the galley cart.

FIG. 7 is a representation of a partial side elevation view of the suspended galley cart showing a pull out tray of the galley cart.

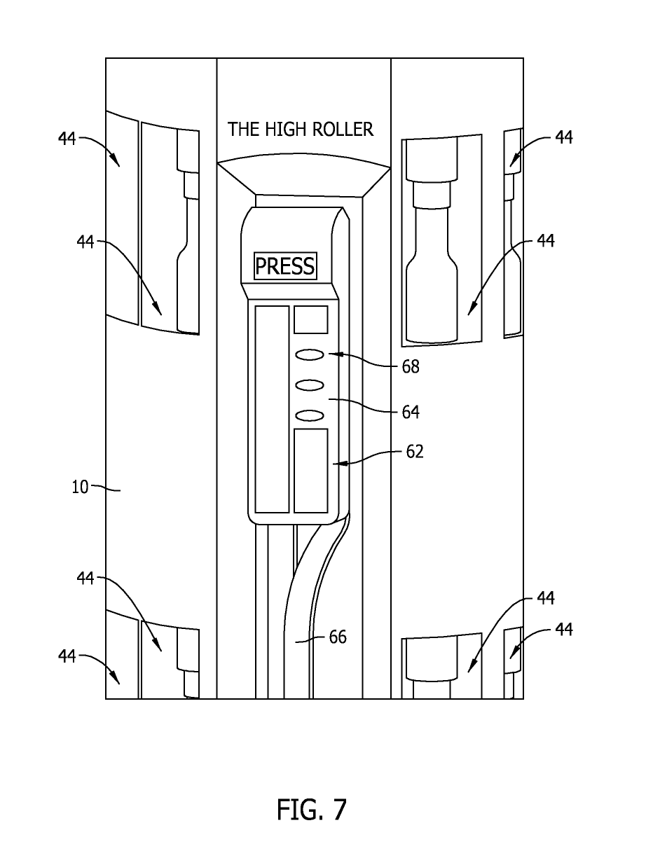

### DETAILED DESCRIPTION

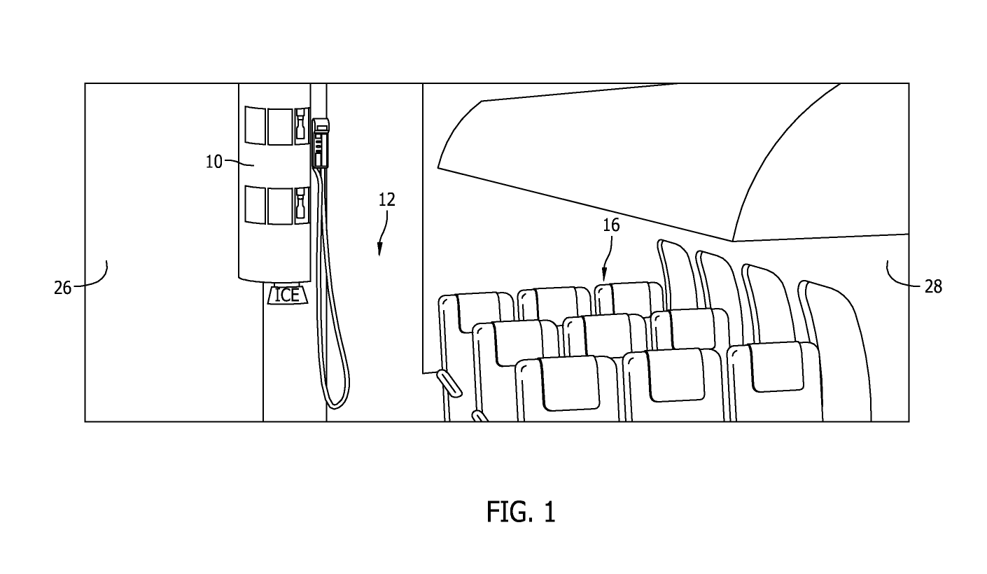

Referring to FIG. 1, the rail mounted food product and beverage dispensing galley cart 10 of the present invention is shown in its operative environment of an aircraft cabin 12. As can be seen in FIG. 1, the galley cart 10 is suspended from the top of the aircraft cabin above the floor surface 14 and above and between the rows of passenger seats 16. As stated earlier, the suspended galley cart 10 is a simple, sleek and efficient replacement for the bulky, obtrusive airline galley carts of the prior art.

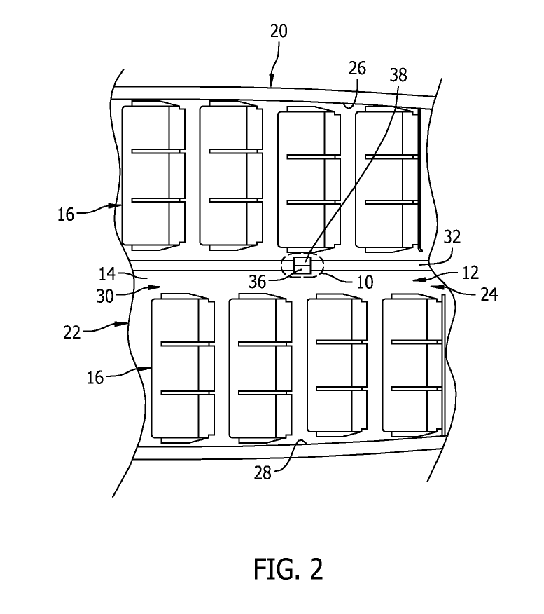

Referring to FIG. 2, a representation of the positioning of the suspended galley cart 10 in an aircraft cabin 12 is shown. In FIG. 2, the suspended galley cart 10 is shown employed in a typical commercial aircraft having a fuselage 20 containing the aircraft cabin 12. The aircraft cabin 12 has a longitudinal length between a front 22 of the aircraft cabin and a rear 24 of the aircraft cabin. The aircraft cabin 12 also has a lateral width between opposite first 26 and second 28 interior sidewalls of the aircraft cabin. The plurality of rows of seats 16 are arranged on the floor surface 14 on laterally opposite sides of the aircraft cabin and define an aisle 30 between the rows of seats. The aisle 30 extends longitudinally across the floor surface 14 between the front 22 of the aircraft cabin and the rear 24 of the aircraft cabin.

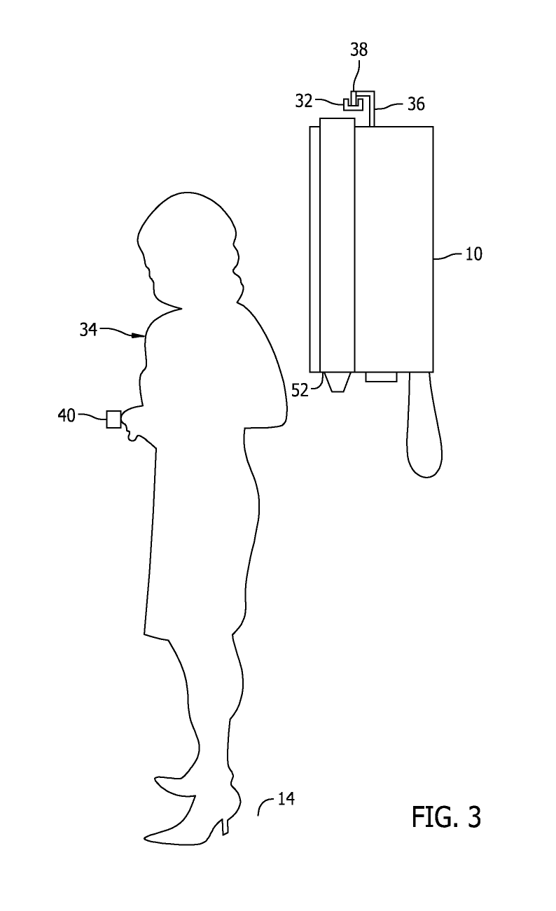

A rail or track 32 extends longitudinally through the aircraft cabin 12 at the top of the aircraft cabin. The rail 32 is shown in FIG. 2 extending between the front 22 of the aircraft cabin 12 and the rear 24 of the cabin. The rail 32 is positioned above the aisle 30 defined between the pluralities of rows of seats 16. The galley cart 10 is suspended from the rail 32. As can be seen in FIG. 1, the rail 32 suspends the galley cart 10 above the aisle 30 and above the plurality of rows of seats 16. FIG. 3 shows a representation of the vertical height of the suspended galley cart 10 relative to a flight attendant 34 standing in the aisle 30 on the aircraft floor surface 14. FIG. 3 also shows a schematic representation of a support member 36 extending from the top of the suspended galley cart 10 to the rail 32, and a schematic representation of a motive device 38 provided at the connection of the support member 36 and the rail 32. Selective operation of the motive device 38 controls movement of the suspended galley cart 10 longitudinally through the aircraft cabin 12 between the front 22 of the aircraft cabin and the rear 24 of the aircraft cabin. The motive device 38 could be any type of device that is selectively operable to move the suspended galley cart 10 longitudinally through the aircraft cabin 12. For example, the motive device 38 could include an electric motor that rotates a pinion gear that engages with a rack that extends along the rail 32. Selectively operating the motor to rotate the pinion gear in different directions would control the longitudinal movement of the suspended galley cart 10 along the rail 32. Alternatively, the motive device 38 could be a screw and nut assembly where rotation of the screw in opposite directions moves the suspended galley cart 10 longitudinally in opposite directions along the rail 32. Still further, the motive device 38 could be a sprocket and chain drive assembly or a pulley and belt assembly that can be selectively driven to move the suspended galley cart 10 longitudinally through the aircraft cabin 12. Other equivalent motive devices 38 could also be employed with the suspended galley cart 10 and rail 32.

The selective operation of the motive device 38 could be controlled by a wireless control device 40 represented schematically in FIG. 3. The control device 40 is shown being carried by a flight attendant 34. The control device 40 is operable by the flight attendant to transmit control signals to the motive device 38 that control the operation of the motive device to move the suspended galley cart 10 longitudinally through the aircraft cabin 12. Furthermore, the control device 40 could selectively operate the motive device 38 to move the suspended galley cart 10 in a particular direction and for a particular distance in response to movements of the flight attendant 34 through the aircraft cabin 12 a particular distance. For example, the motive device 38 could be controlled to move the suspended galley cart 10 from one row to the next in response to the flight attendant moving a distance corresponding to the distance between adjacent rows. The wireless control device 40 could communicate with the motive device 38 in any known wireless manner, for example, by radio frequency identification device (RFID), wifi, bluetooth, wi-max, optical, by voice and audio commands, or through a power line physically connecting the control device 40 with the motive device 38. Additionally, there could be other options for flight attendant operation. The attendant could push/pull the cart, the cart could follow the flight attendant with an RF sensor, or the cart could be motorized and move on its own with the flight attendant just controlling stop and start.

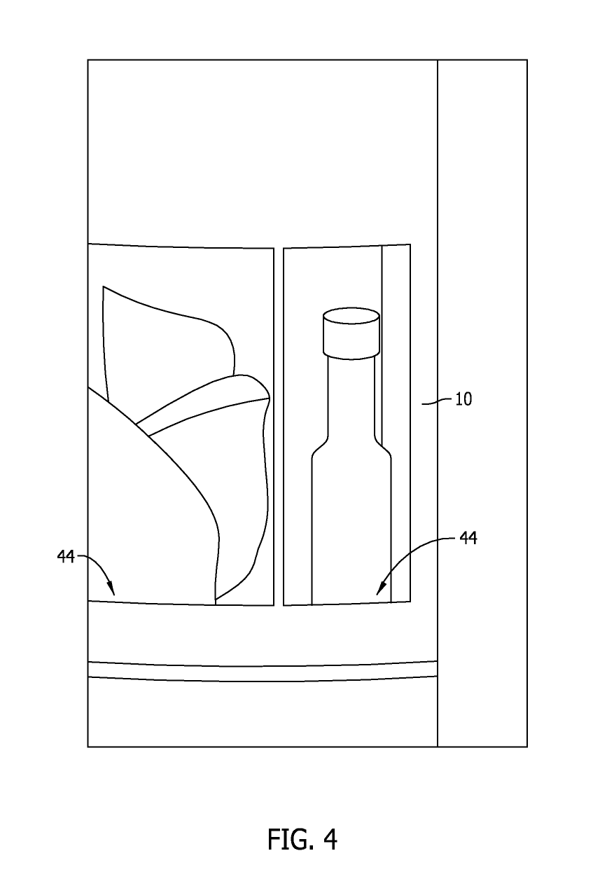

As represented in FIGS. 1 and 4, the suspended galley cart 10 is provided with a plurality of open bins 44 for storing food products, for example, packages of snacks. The bins 44 could also be used to store other products such as small bottles of spirits, or to store napkins or other similar articles.

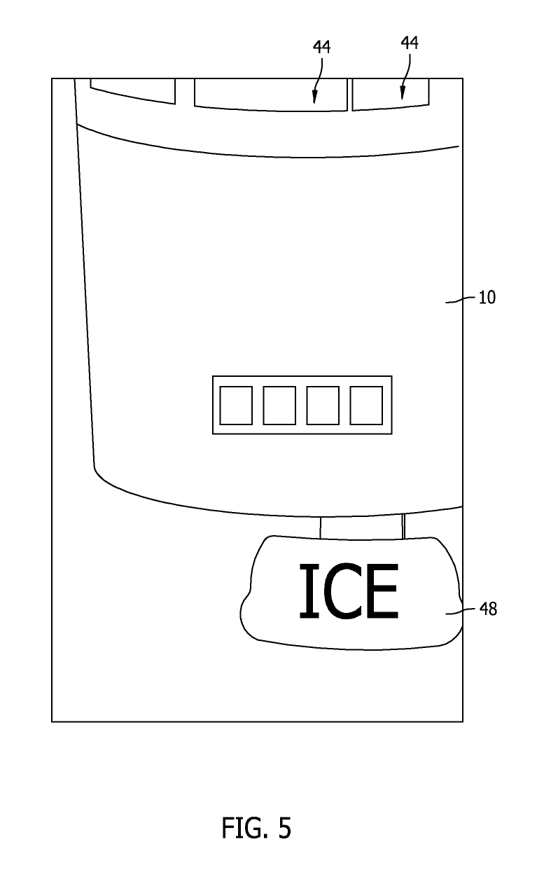

The suspended galley cart 10 is also provided with an ice dispenser 48. This is represented in FIG. 5. The ice dispenser 48 can be selectively operated by the flight attendant to dispense cubed or crushed ice for drinks.

A drink cup holder 52 is provided on one side of the suspended galley cart 10. This is represented in FIG. 3. The drink cup holder 52 is positioned where it is easily accessible by the flight attendant to remove a drink cup from the holder and dispense ice from the ice dispenser 48 into the drink cup.

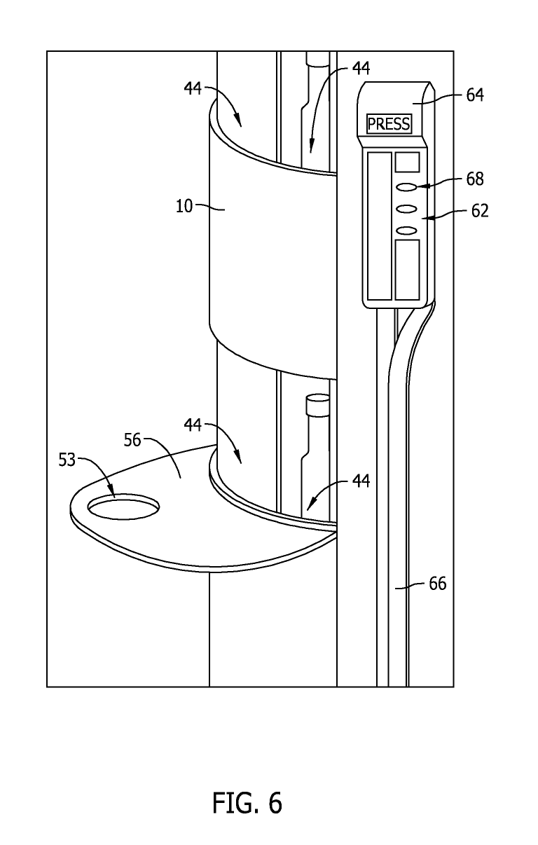

A pull out tray 56 is provided on a side of the suspended galley cart 10. The tray 56 is connected by a pivot connection to the suspended galley cart 10 and can be pulled out from the cart as represented in FIG. 6 to provide a flat tray surface. As represented in FIG. 6, the tray 56 is provided with a hole 58 dimensioned to hold a drink cup. When the tray 56 is no longer being used, it can be pushed back into the side of the suspended galley cart 10.

A beverage dispenser 62 is provided on the side of the suspended galley cart 10 adjacent the tray 56 and the drink cup holder 52. The beverage dispenser 62 includes a hand operated bar soda gun 64 that communicates through a retractable hose 66 with supplies of several different types of beverages. The beverages could be stored inside the suspended galley cart 10, or could be supplied to the soda gun 64 through separate conduits for each of the beverages from supplies of the beverages in a galley area at the aircraft cabin rear 24. The beverage dispenser soda gun 64 is of a type commonly seen at sporting event or movie venue concession stands where the soda gun 64 has a plurality of buttons 68 that are selectively depressed to select between a plurality of different beverages to be dispensed by the soda gun. In a further embodiment of the suspended galley cart two beverage dispensers could be provided for dispensing hot and cold beverages, respectively. The beverage dispenser 62 eliminates the need to open pop top cans or screw cap bottles for beverages and also eliminates the waste of empty cans and bottles.

If desired, a sales register (not shown) could be provided on the suspended galley cart 10 for sales transactions. The sales register could be provided with an automated prompter or screen display that automatically requests payment via cash, debit card or credit card for a sales transaction.

The suspended galley cart 10 weighs approximately 30 pounds, compared to the approximate weight of 200 pounds of a conventional galley cart. The light weight of the suspended galley cart 10 compared to a conventional galley cart not only decreases the fuel usage of the aircraft employing the suspended galley cart 10, but also decreases the risk of injury resulting from pushing a 200 pound galley cart through the aircraft or being struck by a rolling galley cart during turbulence.

The ease of moving the suspended galley cart 10 through the aircraft compared to moving a conventional galley cart through the aircraft, and the food products and beverages of the suspended galley cart 10 being more readily accessible compared to those of a conventional galley cart results in a reduction of time required for a flight attendant to serve food products and beverages to passengers of an aircraft.

As various modifications could be made in the construction of the rail mounted suspended galley cart and its method of use herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

1. A method of delivering food and drink products to passengers on a transporting vehicle, the method comprising:
suspending a cart in an interior of the vehicle, the cart storing food products and a beverage dispenser; and,
electronically linking the cart to a service attendant in the vehicle interior whereby the cart automatically moves through the vehicle interior in response to the service attendant moving through the vehicle interior.

2. The method of claim 1, further comprising:
suspending the cart from a rail that extends through the vehicle interior and moving the cart through the vehicle interior along the rail.

3. The method of claim 1, further comprising:
electronically, wirelessly linking the cart with the service attendant.

4. The method of claim 1, further comprising:
connecting the beverage dispenser to the cart with a retractable hose.

5. The method of claim 1, further comprising:
storing the food products in an open bin on the cart.

6. The method of claim 1, further comprising:
providing a pull out tray surface on the cart that can be pulled out from a side of the cart and pushed back into the side of the cart.

7. The method of claim 1, further comprising:
providing a sales register on the cart.

8. The method of claim 1, further comprising:
moving the cart a distance through the vehicle interior that corresponds to a distance between adjacent rows of passenger seats in response to the service attendant moving through the vehicle interior between adjacent rows of passenger seats.

9. The method of claim 1, further comprising:
the vehicle being an aircraft having a plurality of rows of seats arranged along an interior of the aircraft; and,
moving the suspended cart from a galley area of the aircraft interior through the aircraft interior between the plurality of rows of passenger seats.

10. An aircraft comprising:
an aircraft fuselage containing an aircraft cabin, the aircraft cabin having a longitudinal length between a front of the aircraft cabin and a rear of the aircraft cabin, and the aircraft cabin having a lateral width between opposite first and second interior sidewalls of the aircraft cabin;
a floor surface in the aircraft cabin; and,
a galley cart suspended above the floor surface in the aircraft cabin, the galley cart being moveable longitudinally through the aircraft cabin interior.

11. The aircraft of claim 10, further comprising:
a support member attached between the galley cart and a structure of the aircraft cabin interior, the support member holding the galley cart suspended above the floor surface, and the support member being moveable longitudinally through the aircraft cabin interior to move the galley cart longitudinally through the aircraft cabin interior.

12. The aircraft of claim 11, further comprising:
a rail above the aircraft cabin interior, the rail extending longitudinally through the aircraft fuselage;
the support member extending downwardly from the rail above the aircraft cabin interior and suspending the galley cart from the rail above the aircraft cabin interior.

13. The aircraft of claim 11, further comprising:
the galley cart having beverage storage.

14. The aircraft of claim 11, further comprising:
the galley cart having a beverage dispenser.

15. The aircraft of claim 11, further comprising:
a motive device operatively connected to the galley cart to move the galley cart longitudinally through the aircraft cabin interior on operation of the motive device.

16. The aircraft of claim 15, further comprising:
a control device communicating with the motive device, the control device being operable by a service attendant in the aircraft cabin interior to control operation of the motive device and movement of the galley cart through the aircraft cabin interior.

17. The aircraft of claim 16, further comprising:
the control device wirelessly communicating with the motive device with the control device being separate from and not connected to the motive device.

18. An aircraft comprising:
a fuselage containing an aircraft cabin, the aircraft cabin having a longitudinal length between a front of the aircraft cabin and a rear of the aircraft cabin, and the aircraft cabin having a lateral width between opposite first and second interior sidewalls of the aircraft cabin;
a floor surface in the aircraft cabin;
a plurality of rows of seats on the floor surface, the rows of seats being arranged on laterally opposite sides of the aircraft cabin and defining an aisle between the rows of seats, the aisle extending longitudinally across the floor surface between the front of the aircraft cabin and the rear of the aircraft cabin;
a rail extending longitudinally through the aircraft cabin; and,
a galley cart on the rail with the rail holding the galley cart above the aisle and above the floor surface, the galley cart being moveable along the rail to move the galley cart longitudinally through the aircraft cabin.

19. The aircraft of claim 18, further comprising:
the galley cart containing food products and having a beverage dispenser.

20. The aircraft of claim 19, further comprising:
a motive device operatively connected to the galley cart to move the galley cart longitudinally along the rail and through the aircraft cabin; and,
a control device in wireless communication with the motive device, the control device being operable by a service attendant in the aircraft cabin to control operation of the motive device and the movement of the galley cart longitudinally through the aircraft cabin.
